(19) United States
(12) Patent Application Publication
(10) Pub. No.: US 2008/0065811 A1
(43) Pub. Date: Mar. 13, 2008

(54) Tool and method for forensic examination of a computer

(76) Inventor: Ali Jahangiri, Dubai (AE)

Correspondence Address: LOUIS VENTRE, JR, 2483 OAKTON HILLS DRIVE, OAKTON, VA, 22124-1530, US

(21) Appl. No.: 11/938,389

(22) Filed: Nov. 12, 2007

(51) Int. Cl. G06F 12/00; G06F 13/28; G06F 13/00

(52) U.S. Cl. 711/100

(57) ABSTRACT

A tool and method for automated evidence gathering from a computer hard drive. The tool comprises a computer memory device on which resides a client program. A graphical user interface allows election of the source drive; election of the destination storage medium; and, starting data extraction. The client program copies forensic data from pre-programmed forensic data paths on the source drive to the destination storage medium while preserving the MD5 checksum of the data for file integrity. Data folder names are redesignated to correspond to a categorization of the data based on its location on the target computer. The client program is operable produce a report with the name of the forensic data and the MD5 checksum of the forensic data. The method includes loading the client program on the target computer; electing an operating system; electing a source drive; electing a destination storage medium; and, starting data extraction.

### FIELD OF INVENTION

In the field of computer forensics, a tool and corresponding method for automated evidence gathering from a computer hard drive or other computer storage device.

### BACKGROUND OF THE INVENTION

Currently, computer forensics are undertaken based on searching a computer for the certain type of the evidence, such as for example, searching through the temporary files or the files with the TMP extensions. Electronic forensics is increasingly important for investigative disciplines, such as in civil litigation and crime detection. But it also has uses in private and commercial disciplines. For example, parents and other computer owners are increasingly desirous of monitoring computer usage; and, companies sometimes have need to investigate employee misconduct, wrongdoing and fraud.

Cyber forensic investigators examine data stored in a computer's hard drive or other storage medium to conduct the cyber forensic investigations. Such data contains information about the activities performed with the computer, which is under investigation. Typically, forensic investigators would study the temporary files and folders, the system files, the computer software or application files, log files and the temporary files which are related to certain computer software. These data provide the means to prove a user's activities and often constitute digital evidence that may be used to take further action.

The process of computer forensics has heretofore been a hit or miss search of a hard disk for one or more specific types of the files thought to be relevant. A forensics search often targets and manages relevant information through keyword searching, filtering, data culling, and indexing. The data location and extraction process is labor intensive and can typically take days to months of effort to complete and the conversion of the data to useful files is susceptible to the vagaries of human error.

There is a need for an automated tool that substantially reduces the labor intensity of the process and can rapidly extract forensic evidence from a computer storage device, such as for example within an hour for a 120 gigabyte hard drive. There is a need for a forensic tool that automatically saves the data in an easily recognizable naming and organizational structure that preserves the traceabilty and authenticity of the recovered forensic data to ensure that it is valid and reliable evidence.

A solution in the form of the present invention was developed after extensive research involving various computer operating systems, a methodical characterization of the locations of forensic information for each such computer operating system, and the development of a program to aid in the automated extraction and transforms the information by storage into an organized system that preserves its source identification and integrity.

### DESCRIPTION OF PRIOR ART

Tools and methods employing software to assist in a forensic evaluation of a computer hard drive exists in various embodiments. These typically require intensive user participation via a graphical user interface, including for example input of search terms and intensive evaluation of the data to be extracted and stored. While a graphical user interface is used in the current invention, its is greatly simplified to election of the operating system, the drive where data is stored, the destination location where the extracted forensic data is to be stored and a button to start the process. No search words are needed or used and no evaluation of the data is performed prior to extraction and storage.

Unlike the present invention, which is fully automated as to the extraction and storage of forensic data, such prior art typically attempts to guide a user through various steps in conducting a complicated forensic examination and then extract and store the desired information. In addition, the prior art generally does not provide the means to automatically index and categorize the evidence in a manner that preserves the identification of its source location, simplifies its subsequent analysis and virtually eliminates human error and chain of custody issues.

One example of this type of prior art is United States Patent Application 20070226170 (“170 application”), which discloses an electronic forensic tool for conducting electronic discovery and computer forensic analysis. The 170 application teaches that a device usable by a non-technical person such as a non-forensic expert to conduct electronic discovery and thereby obviate the need for an expert in many situations. It also teaches a business method for electronic discovery involving a software program and a command server for generating expanded functionality. Using software, a user boots a computer and examines the electronic contents. The software enables the user to conduct limited examination of available data, which is facilitated through the use of a graphical user interface.

Some prior art also enables a remote user to view the computer evidence acquired from the target computing device. An example of this type of prior art is United States patent application 20040260733 published Dec. 23, 2004, which teaches techniques for allowing a user to remotely interrogate a target computing device through a graphical user interface. Remote operability allows the user to interrogate the target computing device to acquire the computer evidence without seizing or otherwise shutting down the target device. While remote operability is an added feature, this type of prior art requires the same type of user interaction involving a complicated forensic examination and decision structure leading to the extraction and storage of the desired information.

Accordingly, the present invention will serve to improve the state of the art by providing an automated system and method that rapidly finds forensic evidence, documents the origin of extracted data, saves the original information without alteration in an indexed categorization system and virtually eliminates human error and chain of custody issues. The present invention improves the state of the art by reducing the time needed for reliable forensics data extraction from potentially months of effort to about an hour.

### BRIEF SUMMARY OF THE INVENTION

A tool and method for automated evidence gathering from a computer hard drive or other computer storage device. The tool comprises a computer memory device on which resides a client program. The client program is operable by the target computer's operating system. The client program presents a graphical user interface that allows a user to implement acts comprising election of the operating system on the target computer; election of the source drive where forensic data is stored; election of the destination storage medium where extracted forensic data is to be stored; and, starting data extraction. The client program copies forensic data from pre-programmed forensic data paths on the source drive to the destination storage medium while preserving the MD5 checksum of the data for file integrity. The client program redesignates a data folder name to correspond to a categorization of the data based on its location on the target computer. The client program is operable produce a report with the name of the forensic data and the MD5 checksum of the forensic data.

The method uses the tool to conduct electronic forensic examination on a target computer. Steps include loading the client program on the target computer; electing an operating system; electing a source drive; electing a destination storage medium; and, starting data extraction.

### BRIEF DESCRIPTION OF THE DRAWINGS

FIG.1 is a flow diagram of a process of using the invention for forensic examination of a computer.

### DETAILED DESCRIPTION

In the following description, reference is made to the accompanying drawing, which forms a part hereof and which illustrates several embodiments of the present invention. The drawing and the preferred embodiments of the invention are presented with the understanding that the present invention is susceptible of embodiments in many different forms and, therefore, other embodiments may be utilized and structural and operational changes may be made without departing from the scope of the present invention.

The apparatus of the invention is a tool for extracting forensic data from a target computer. A target computer is one in the ordinary sense of a computer. Typically, a computer has a hard disk for storing programs, files and other digital information, random access memory to operate the programs, and an operating system, such as MICROSOFT WINDOWS XP and MICROSOFT WINDOWS VISTA. An alternative embodiment provides a radio button and limits the election of the operating system on the target computer comprises to either MICROSOFT WINDOWS XP or MICROSOFT WINDOWS VISTA.

The tool comprises a computer memory device on which resides a client program. The computer memory device may be any such device capable of storing the client program, for example, portable and network-accessible computer memory devices. Typical examples of portable computer memory devices include a compact disk, digital video disk, removable flash memory card, removable drive, a USB flash drive, and a ZIP disk. A typical example of a network accessible-computer memory device is a remote server accessible via an Internet connection.

The client program is operable by the target computer's operating system. This essentially means that client program on the computer memory device must be accessible and readable by the target computer.

Once in operation, the client program presents a graphical user interface on the target computer so that a user can make an election as to the operating system on the target computer, make an election as to the source drive where forensic data is stored, make an election as to the destination storage medium where extracted forensic data is to be stored. These elections enable the program to automatically function in extracting forensics data from the target computer. Once these elections are made, the graphical user interface enables the user to start data extraction.

In an alternative embodiment the graphical user interface further allows selection of a user account on the target computer. Most operating systems all computers to have files and programs restricted to various users. This selection option would limit the data extraction to the particular user being investigated.

For embodiments where a user is selected, the client program is further operable by the target computer's operating system to create a first folder on the destination storage medium with the name of the target computer and create inside of the first folder a second folder with the name of the user account from which the forensic data is extracted.

Data extraction copies forensic data from pre-programmed forensic data paths on the source drive to the destination storage medium. The client program automatically calls up the pre-programmed forensic data paths based on the operating system selected by the user. Preferably, each operating system has a corresponding data file apart from the program file, wherein the data file lists the paths for that operating system. Thus, for a preferred embodiment, the pre-programmed forensic data paths are in a data file, wherein the data file lists the paths for a single operating system.

A separate data file permits the client program to be easily updated with a revised data file whenever the paths need to be changed or supplemented due to revisions in a computer operating system or computer program or when a new user program is created.

Data extraction preserves the MD5 checksum of the data for file integrity. The MD5 checksum (Message-Digest algorithm 5) for a file is typically a 128-bit value, akin to a fingerprint of the file. There is a very small possibility of getting two identical checksums of two different files. This feature is useful both for comparing the files and for their integrity control.

Data extraction also redesignates a data folder name to correspond to a categorization of the data based on its location on the target computer.

The client program also operable to produce a report comprising the name of the forensic data and the MD5 checksum of the forensic data. This report may be saved for display elsewhere or may be displayed on the target computer.

In an alternative embodiment, the client program is further operable to determine the target computer's network connections and open ports and for this embodiment, the report would further contain this information.

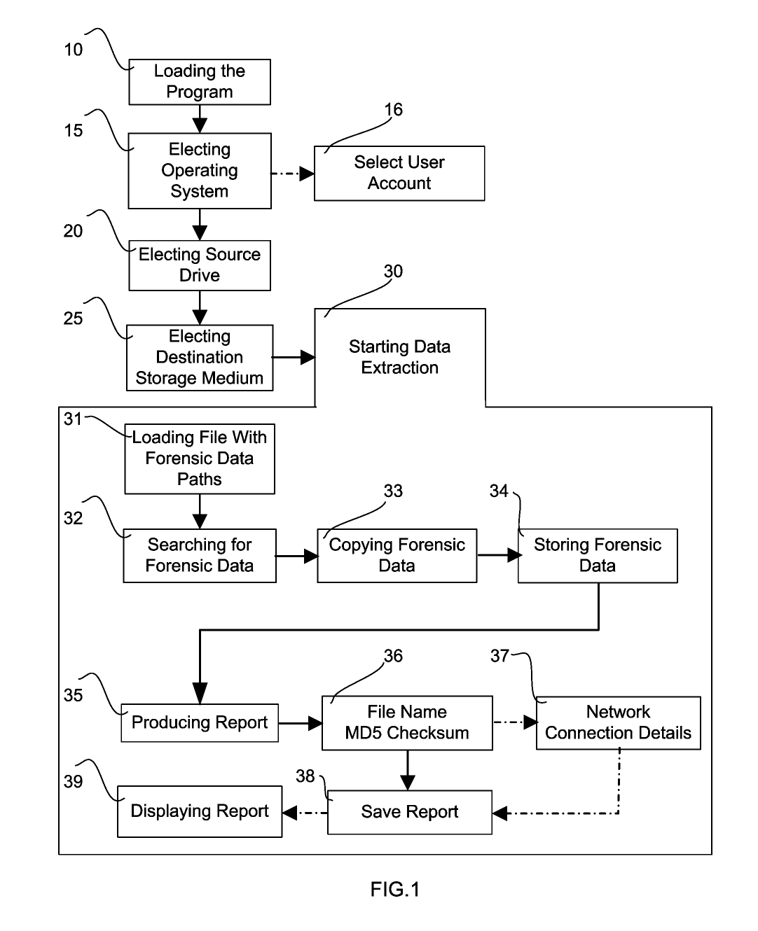

FIG.1 is a flow diagram of a method using a preferred embodiment of the invention as described above with some optional steps representing alternative embodiments. The optional steps are shown with dashed arrows. The method enables an electronic forensic examination of a target computer by implementing the steps of loading the client program on the target computer (10); electing an operating system (15); electing a source drive (20); electing a destination storage medium (25); and, starting data extraction (30).

While starting data extraction runs the extraction program, this step may be further limited by the functionality of the client program wherein the client program implements steps comprising: loading a file from the computer memory device, said file containing pre-programmed forensic data paths located on the elected source drive as relevant to the elected operating system (31); searching for forensic data on the elected source drive using the pre-programmed forensic data paths (32); copying forensic data found from searching for forensic data on the elected source drive using the pre-programmed forensic data paths (33); storing the copied forensic data on the destination storage medium while preserving the MD5 checksum of the data for file integrity and redesignating a data folder name to correspond to a categorization of the data based on its location on said target computer (34); and, producing the report (35). As described above, the report contains the file name of the forensic data and the MD5 checksum of the forensic data (36) and it may optionally contain network connection details (37). Producing the report includes saving the report (38), typically on the destination storage medium, and, optionally, displaying the report (39).

Example 1—pre-programmed forensic data paths on a source drive and redesignated destination folder names.

The current possible source paths for the MICROSOFT WINDOWS VISTA operating system including the folders name which to be used to copy forensic data and the destination folder names to store the forensic data:
Source Path: \users\%username%\AppData\Local\Temp
Destination Folder: \TempFiles\
Source Path: \users\%username%\AppData\Roaming\Microsoft\Windows\Recent
Destination Folder: \RecentFiles\
Source Path: \users\%username%\AppData\Roaming\Microsoft\Windows\Network Shortcuts
Destination Folder: \NetworkShortcuts\
Source Path: \users\%username%\AppData\Roaming\Microsoft\Windows\Printer Shortcuts
Destination Folder: \PrinterShortcuts\
Source Path : \users\%username%\AppData\Roaming\Microsoft\Windows\Web Server Extensions
Destination Folder: \WebServerExtensions\
Source Path: \users\%username%\AppData\Roaming\Microsoft\ActiveSync
Destination Folder: \ActiveSync\
Source Path: \users\%username%\AppData\Roaming\Microsoft\Installer
Destination Folder: \InstalledProgramRecords\
Source Path: \users\%username%\AppData\Roaming\Microsoft\MSN Messenger
Destination Folder: \MSNMessenger\
Source Path: \users\%username%\AppData\Roaming\Microsoft\UProof
Destination Folder: \MSOfficeRecords\
Source Path: \users\%username%\AppData\Roaming\Microsoft\Office\Recent
Destination Folder: \Office07RecentFile\
Source Path: \users\%username%\AppData\Local\Microsoft\Windows\Temporary Internet Files
Destination Folder: \TempInternetFiles\
Source Path: \users\%username%\AppData\Roaming\Microsoft\Windows\Cookies
Destination Folder: \IECookies\
Source Path: \users\%username%\AppData\Local\Microsoft\Windows Live Contacts
Destination Folder: \WindowsLive\
Source Path: \users\%username%\AppData\Local\Microsoft\Windows Calendar
Destination Folder: \WindowsCalendar\
Source Path: \users\%username%\AppData\Local\Microsoft\Windows Mail
Destination Folder: \WindowsMail\
Source Path: \users\%username%\AppData\Roaming\Mozilla\Firefox\Profiles
Destination Folder: \FireFox\
Source Path: “\users\%username%\AppData\Roaming\Microsoft\Crypto
Destination Folder: \SavedPasswords-Crypto\
Source Path: \users\%username%\AppData\Local\Microsoft\Outlook
Destination Folder: \Outlook07\
Source Path: \users\%username%\AppData\Local\Microsoft\OIS
Destination Folder: \ViewedPictures\
Source Path: \users\%username%\AppData\Local\Microsoft\Media Player
Destination Folder: \MediaPlayer\
Source Path: \users\%username%\AppData\Local\Microsoft\Office
Destination Folder: \OfficeETC\
Source Path: \users\%username%\AppData\Local\Microsoft\Signatures
Destination Folder: \OfficeSignatures\
Source Path: \users\%username%\AppData\Local\Microsoft\Terminal Server Client
Destination Folder: \TerminalServerClient\
Source Path: \users\%username%\AppData\Local\Microsoft\Windows Defender
Destination Folder: \WindowsDefender\
Source Path: \$recycle.bin
Destination Folder: \RecycleBin\
Source Path: \System.Sav\
Destination Folder: \SystemSave\
Source Path: \users\%username%\Searches
Destination Folder: \SearchesRecords\
Source Path: “\users\%username%\Contacts
Destination Folder: \ContactsRecords\
Source Path: \users\%username%\Desktop
Destination Folder: \DeskTop
Source Path: \users\%username%\Documents
Destination Folder: \Documents\
Source Path: \users\%username%\Downloads
Destination Folder: \DownloadsRecords\
Source Path: \users\%username%\Favorites
Destination Folder: \IEFavorites\
Source Path: \users\%username%\Links
Destination Folder: \Links\
Source Path: \users\%username%\Music
Destination Folder: \Music\
Source Path: \users\%username%\Pictures
Destination Folder: \Pictures\
Source Path: \users\%username%\Videos
Destination Folder: \Videos\
Source Path: \users\%username%\Links
Destination Folder: \Links\
Source Path: \Windows\security
Destination Folder: \SecurityLogs\
Source Path: \Windows\SoftwareDistribution
Destination Folder: \ApplicationLogs-lnfo\
Source Path: \Windows\System32\config
Destination Folder: \WindowsConfig\
Source Path: \Windows\Prefetch
Destination Folder: \WindowsPrefetch\
Source Path: \Program Files\Netscape\Navigator\Cache
Destination Folder: \Netscape\NavigatorCash\
Source Path: \Program Files\Netscape\Users\default\Cache
Destination Folder: \Netscape\UsersCash\
Source Path: Program Files\Netscape\Users\default
Destination Folder: \Netscape\UsersCash\
Source Path: \Program Files\Netscape\Navigator\Mail
Destination Folder: \Netscape\Mail\
Source Path: \Program Files\Netscape\Users\default\Mail
Destination Folder: \Netscape\Mail\Users
Source Path: \Windows\Internet Logs
Destination Folder: \InternetLog\
Source Path: \Windows\ModemLogs
Destination Folder: \ModemLog\
Source Path: \program files\divx\divx player
Destination Folder: \DivxRecords\
Source Path: \Program Files\Qualcomm\Eudora
Destination Folder: \EudoraRecords\
Source Path: \users\%username%\AppData\Local\Roaming\Opera
Destination Folder: \Opera\
Source Path: \Program Files\Opera75\profile
Destination Folder: \Opera\Profile\
Source Path: \Program Files\Opera
Destination Folder: \Opera\Opera 2\
Source Path: \Users\%username%\AppData\Roaming\Microsoft\Credentials
Destination Folder: \Win-Credentials\
Source Path: \Users\%username%\AppData\Local\Microsoft\Credentials
Destination Folder: \Win-Credentials 2\
Source Path: \Users\%username%\AppData\Roaming\Microsoft\SystemCertificates
Destination Folder: \SystemCertificates\
Source Path: \Users\%username%\AppData\Roaming\Symantec
Destination Folder: \SymantecRecords\
Source Path: \Users\%usernmae%\AppData\Local\Microsoft\Feeds
Destination Folder: \FeedsRecords\
Source Path: \users\%username%\appdata\local\Skype\Phone
Destination Folder: \Skype\Phone
Source Path: \users\%username%\appdata\Roaming\Skype\Phone
Destination Folder: \Skype\Phone1
Source Path: \users\%username%\AppData\Roaming\Skype
Destination Folder: \Skype\Skype\
Source Path: \users\%username%\AppData\Local\Skype
Destination Folder: \Skype\Skype2\
Source Path: \ProgramData\Microsoft\Search
Destination Folder: \SearchsRecords 2\
Source Path: \Users\%username%\AppData\Local\Microsoft\Messenger
Destination Folder: \MsnMessenger 2\

Example 2—pre-programmed forensic data paths on a source drive and redesignated destination folder names.

The current possible source paths for the MICROSOFT WINDOWS XP operating system operating system including the folders name which to be used to copy forensic data and the destination folder names to store the forensic data:
Source Path: \recycled
Destination Folder: \RecycleBin\
Source Path: \Documents and Settings\%username%\Local Settings\Temp
Destination Folder: \TempFiles\
Source Path: \Documents and Settings\All Users\Application Data\Microsoft\OFFICE
Destination Folder: \MSOffice\
Source Path: \WINDOWS\system32\CatRoot2
Destination Folder: \CryptoService-CatRoot\
Source Path: \Documents and Settings\%username%\Application Data\Mozilla\Firefox\Profiles
Destination Folder: \Firefox\
Source Path: \Documents and Settings\%username%\Application Data\Mozilla\Firefox
Destination Folder: \Firefox 2\
Source Path: \Documents and Settings\%username%\Local Settings\Application Data\Mozilla\Firefox
Destination Folder: \Firefox 3\
Source Path: \WINDOWS\system32\CatRoot2
Destination Folder: CryptoService-CatRoot
Source Path: \WINDOWS\security\
Destination Folder: \WindowsSecurity\
Source Path: \WINDOWS\SoftwareDistribution\
Destination Folder: \ApplicationLogs-lnfo\
Source Path: \WINDOWS\system32\config
Destination Folder: \WindowsConfig\
Source Path: \WINDOWS\prefetch
Destination Folder: \WindowsPrefetch\
Source Path: \Windows\temp
Destination Folder: \WindowsTempFiles\
Source Path: \WINDOWS\temp\History\History.\IE5
Destination Folder: \IEHistory\
Source Path: \Documents and Settings\%username%\Local Settings\Temp
Destination Folder: \TempFiles 2\
Source Path: \Documents and Settings\%username%\Recent
Destination Folder: \RecentFiles\
Source Path: \Documents and Settings\%username%\Local Settings\Temporary Internet Files
Destination Folder: \TempInternet Files\
Source Path: \Documents and Settings\%username%\Local Settings\History
Destination Folder: \WindowsExplorerHistory\
Source Path: \Documents and Settings\%username%\Local Settings\History\History.\IE5
Destination Folder: \IEHistory 2\
Source Path: \Documents and Settings\%username%\Cookies
Destination Folder: \IECookies\
Source Path: \Documents and Settings\%username%\Application Data\Microsoft\Media Player
Destination Folder: \MediaPlayer\
Source Path: \Documents and settings\all users\Application Data\Microsoft\Media Index
Destination Folder: \MediaIndex\
Source Path: \Program Files\Netscape\Navigator\Cache
Destination Folder: \Netscape\NavigatorCash\
Source Path: \Program Files\Netscape\Users\default\Cache
Destination Folder: \Netscape\UsersCash\
Source Path: \Program Files\Netscape\Users\default
Destination Folder: \Netscape\UsersCash 2\
Source Path: \Program Files\Netscape\Navigator\Mail
Destination Folder: \NavigatorMail\
Source Path: \Program Files\Netscape\Users\default\Mail
Destination Folder: \Netscape\UsersMail\
Source Path: \WINDOWS\repair
Destination Folder: \WindowsRepair\
Source Path: \program files\divx\divx player
Destination Folder: \DivxPlayerRecords\
Source Path: \Program Files\Qualcomm\Eudora
Destination Folder: \EudoraRecords\
Source Path: \Documents and Settings\%username%\Application Data\Microsoft\Office\Recent
Destination Folder: \RecentFiles\
Source Path: \Documents and Settings\%username%\Application Data\Opera
Destination Folder: \Opera
Source Path: \Program Files\Opera75\profile
Destination Folder: \Opera\Profile\
Source Path: \Program Files\Opera
Destination Folder: \Opera 2\
Source Path: \Documents and Settings\%username%\Local Settings\Temporary Internet Files
Destination Folder: \TempInternetFiles\
Source Path: \Documents and Settings\%username%\Local Settings\Application Data\Identities
Destination Folder: \WindowsIdentities\
Source Path: \Documents and Settings\%username%\Application Data\Google
Destination Folder: \Google\
Source Path: \Documents and Settings\%username%\Application Data\Macromedia
Destination Folder: \Macromedia\
Source Path: \Documents and Settings\%username%\Application Data\Microsoft\Address Book
Destination Folder: \AddressBook\
Source Path: \Documents and Settings\%username%\Application Data\Microsoft\Crypto
Destination Folder: \SavedPasswords-Crypto\
Source Path: \Documents and Settings\%username%\Application Data\Microsoft\CryptnetUrlCache
Destination Folder: \CryptnetUrlCache\
Source Path: \Documents and Settings\%username%\Application Data\Microsoft\Network
Destination Folder: \Networks\
Source Path: \Documents and Settings\%username%\Application Data\Microsoft\Office
Destination Folder: \MSOffice 2\
Source Path: \Documents and Settings\%username%\Application Data\Microsoft\Signatures
Destination Folder: \Signatures\
Source Path: \Documents and Settings\%username%\Application Data\Microsoft\SystemCertificates
Destination Folder: \SystemCertificates\
Source Path: \Documents and Settings\%username%\Local Settings\Application Data\Symantec
Destination Folder: \SymantecRecords\
Source Path: \Documents and Settings\%username%\Local Settings\Application Data\Microsoft\Windows Media
Destination Folder: \Windows Media
Source Path: \Documents and Settings\%username%\Local Settings\Application Data\Microsoft\Terminal Server Client
Destination Folder: \TerminalServerClient\
Source Path: \Documents and Settings\%username%\Local Settings\Application Data\Microsoft\Outlook
Destination Folder: \Outlook\
Source Path: \Documents and Settings\%username%\Local Settings\Application Data\Microsoft\OIS
Destination Folder: \ViewedPictures\
Source Path: \Documents and Settings\%username%\Local Settings\Application Data\Microsoft\Internet Explorer
Destination Folder: \InternetExplorer
Source Path: \Documents and Settings\%username%\Local Settings\Application Data\Microsoft\Feeds
Destination Folder: \FeedsRecords\
Source Path: \Documents and Settings\%username%\Local Settings\Application Data\Microsoft\Credentials
Destination Folder: \Windows\Credentials\
Source Path: \WINDOWS\internet logs
Destination Folder: \InternetLogs\
Source Path: \program files\yahoo!
Destination Folder: \Yahoo!\
Source Path: \Documents and Settings\%username%\NetHood
Destination Folder: \NetHood\
Source Path: \Documents and Settings\%username%\Favorites
Destination Folder: \Favorites\
Source Path: \Documents and Settings\%username%\Desktop
Destination Folder: \Desktop\
Source Path: \Documents and Settings\%username%\My Documents
Destination Folder: \My Documents\
Source Path: \appdata\Skype\Phone
Destination Folder: \Skype\
Source Path: \users\%username%\AppData\Roaming\Skype
Destination Folder: \Skype\Skype 2
Source Path: \Documents and Settings\%username%\Application Data\Skype
Destination Folder: \Skype\Skype 3
Source Path: \Documents and Settings\%username%\Local Settings\Application Data\Microsoft\Messenger
Destination Folder: \Messenger\

The above-described embodiments including the drawing are examples of the invention and merely provide illustrations of the invention. Other embodiments will be obvious to those skilled in the art. Thus, the scope of the invention is determined by the appended claims and their legal equivalents rather than by the examples given.

What is claimed is:

1) A tool for extracting forensic data from a target computer comprising a computer memory device on which resides a client program wherein said client program is operable by the target computer's operating system to:
(a) present a graphical user interface wherein a user can implement acts comprising:
(1) election of the operating system on the target computer,
(2) election of the source drive where forensic data is stored,
(3) election of the destination storage medium where extracted forensic data is to be stored, and,
(4) starting data extraction, wherein said data extraction copies forensic data from pre-programmed forensic data paths on the source drive to the destination storage medium while preserving the MD5 checksum of the data for file integrity and redesignating a data folder name to correspond to a categorization of the data based on its location on said target computer; and,
(b) produce a report comprising the name of the forensic data and the MD5 checksum of the forensic data.

2) The tool of claim 1 wherein election of the operating system on the target computer comprises selecting a radio button for either MICROSOFT WINDOWS XP or MICROSOFT WINDOWS VISTA operating system.

3) The tool of claim 1 wherein said client program is further operable by the target computer's operating system to determine the target computer's network connections and open ports.

4) The tool of claim 1 wherein said client program is further operable by the target computer's operating system to display the report on the target computer.

5) The tool of claim 1 wherein the pre-programmed forensic data paths are in a data file, wherein the data file lists the paths for a single operating system.

6) The tool of claim 1 wherein the graphical user interface further allows selection of a user account on the target computer.

7) The tool of claim 6 wherein said client program is further operable by the target computer's operating system to create a first folder on the destination storage medium with the name of the target computer and create inside of the first folder a second folder with the name of the user account from which the forensic data is extracted.

8) A method of using the tool of claim 1 to conduct electronic forensic examination of a target computer comprising the steps of:
(a) loading the client program on the target computer;
(b) electing an operating system;
(c) electing a source drive;
(d) electing a desination storage medium; and,
(e) starting data extraction.

9) The method of claim 8 wherein the step of starting data extraction runs the client program wherein said client program implements steps comprising:
(a) loading a file from the computer memory device, said file containing pre-programmed forensic data paths located on the elected source drive as relevant to the elected operating system;
(b) searching for forensic data on the elected source drive using the pre-programmed forensic data paths;
(c) copying forensic data found from searching for forensic data on the elected source drive using the pre-programmed forensic data paths;
(d) storing the copied forensic data on the desination storage medium while preserving the MD5 checksum of the data for file integrity and redesignating a data folder name to correspond to a categorization of the data based on its location on said target computer; and,
(e) producing the report.
